(19) United States
(12) Patent Application Publication
(10) Pub. No.: US 2019/0031001 A1
(43) Pub. Date: Jan. 31, 2019

(54) SHIELDING A PORTION OF A VEHICLE USING A REMOVABLE VALANCE

(71) Applicant: Fabritec Industries, Inc., d/b/a DoorWorks Enclosures, St. Louis, MO (US)

(72) Inventor: Craig Guempel, St. Louis, MO (US)

(21) Appl. No.: 15/660,017

(22) Filed: Jul. 26, 2017

(51) Int. Cl. B60J 7/00; B62D 33/06

(52) U.S. Cl. CPC B60J 7/0007; B62D 33/0621

(57) ABSTRACT

A system enables a portion of a vehicle to be shielded using a removable valance. The system includes an enclosure panel having an outer surface, a first coupling mechanism coupling the enclosure panel to the vehicle, a valance having an inner surface, and a second coupling mechanism including a first portion coupled to the outer surface of the enclosure panel and a second portion coupled to the inner surface of the valance. The second portion is configured to engage the first portion such that the valance is removably coupleable to the enclosure panel.

### BACKGROUND

Vehicles, such as golf carts, may be used to transport people and/or objects from one location to another. Some conventional golf carts include a roof mounted to a cart frame to protect its occupants from the environment. Conventional golf carts are side-door free to facilitate quick and convenient ingress into the cabin area and egress out of the cabin area. During inclement weather, however, the cabin area of such golf carts may be exposed to weather elements, such as cold temperatures, rain, and/or high winds.

At least some conventional golf carts have an awning, curtain, or other enclosure panel connected to its frame and/or roof to provide protective covering for the cabin area. Known enclosure panels used with golf carts, however, are utilitarian and often prioritize function over fashion. For example, at least a portion of an enclosure panel may be transparent to allow an occupant of a golf cart to see outward from within the cabin area; however, the transparent portion of the enclosure panel also allows others (e.g., a person not in the golf cart) to see the frame and/or frame-enclosure panel interface (e.g., coupling mechanism, track) through the enclosure panel.

To improve an aesthetic quality, an owner of a golf cart may choose to install an enclosure panel with a valance that shields at least a portion of the frame and/or frame-enclosure panel interface. Known valances, however, are fixedly attached (e.g., sewn) onto the enclosure panel, rending installation and/or uninstallation of the valance difficult, onerous, and/or time-consuming.

### SUMMARY

Examples of the disclosure enable a portion of a vehicle to be shielded using a removable valance. In one aspect, a system is provided for shielding a portion of a golf cart. The system includes an enclosure panel having an outer surface, a first coupling mechanism coupling the enclosure panel to the golf cart, a valance having an inner surface, and a second coupling mechanism including a first portion coupled to the outer surface of the enclosure panel and a second portion coupled to the inner surface of the valance. The second portion is configured to engage the first portion such that the valance is removably coupleable to the enclosure panel.

In another aspect, an enclosure system is provided for shielding a portion of a golf cart. The enclosure system includes an enclosure panel having an inner surface and an outer surface opposite the inner surface, a first panel coupling member coupled to the inner surface of the enclosure panel, and a second panel coupling member coupled to the outer surface of the enclosure panel. The first panel coupling member is configured to engage a cart coupling member coupled to the golf cart for removably coupling the enclosure panel to the golf cart. The second panel coupling member configured to engage a valance coupling member coupled to a valance for removably coupling the enclosure panel to the valance.

In yet another aspect, a method is provided for shielding a portion of a golf cart. The method includes coupling an enclosure panel to the golf cart. The enclosure panel has an outer surface with a panel coupling member extending across an upper section of the enclosure panel. The panel coupling member engages a valance coupling member coupled to a valance for removably coupling the valance to the enclosure panel. The valance coupling member extends across an upper section of the valance.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Features, aspects, and advantages of the present disclosure will become better understood when the following Detailed Description is read with reference to the accompanying drawings in which like characters represent like parts throughout, wherein:

FIG. 1 is a perspective view an example golf cart;

FIG. 2 is a schematic view of an example system that may be used to shield a portion of a vehicle, such as the golf cart shown in FIG. 1;

FIG. 3 is a detail perspective view of a portion of the system shown in FIG. 2 in an engaged configuration;

FIG. 4 is a detail perspective view of a portion of the system shown in FIG. 2 in a partially disengaged configuration;

FIG. 5 is a perspective view of the system shown in FIG. 2 in another partially disengaged configuration; and

FIG. 6 is a flowchart of an example method of shielding a portion of the golf cart shown in FIG. 1 using the system shown in FIG. 2.

### DETAILED DESCRIPTION

The present disclosure relates to coupling mechanisms and, more particularly, to a system for shielding a portion of a vehicle using a removable valance. The examples described herein include an enclosure panel having an outer surface, a first coupling mechanism coupling the enclosure panel to the golf cart, a valance having an inner surface, and a second coupling mechanism including a first portion coupled to the outer surface of the enclosure panel and a second portion coupled to the inner surface of the valance. The second portion selectively engages the first portion to removably couple the valance to the enclosure panel. The examples described herein allow a user to install an enclosure panel and valance in a convenient, efficient, safe, and/or economical manner. The examples described herein are lightweight and durable. The examples described herein include a variety of configurations, and the description and/or figures that utilize a golf cart are exemplary only. The examples described herein may be used with any open-sided vehicle, such as personal transport vehicles, tractors, all-terrain vehicles, lawn equipment, construction equipment, and/or farm equipment.

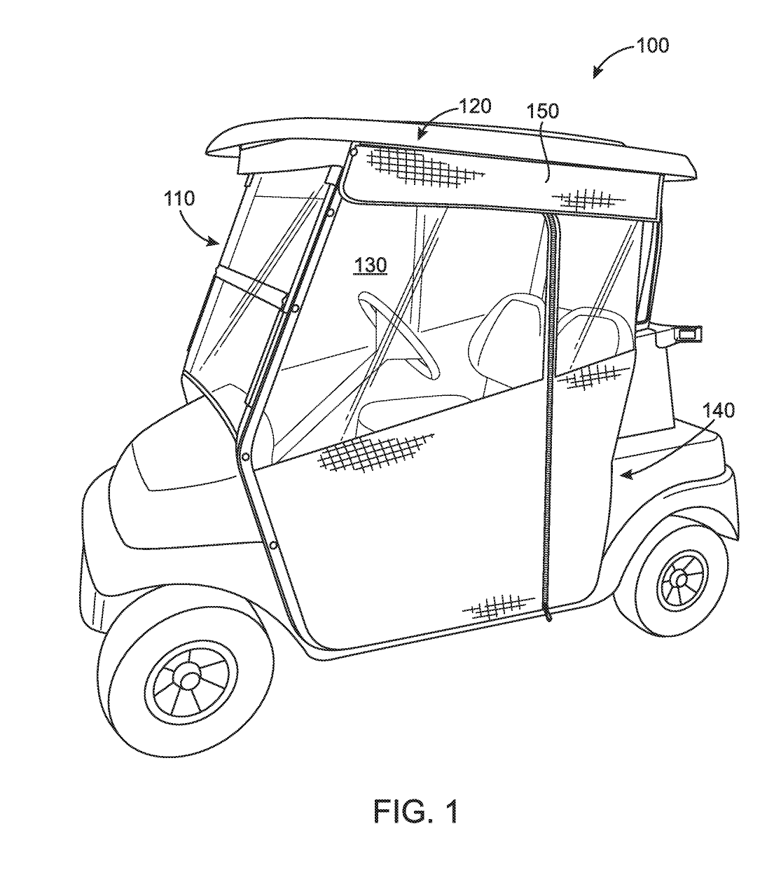

FIG. 1 shows an example golf cart 100. The golf cart 100 includes a frame 110 and a roof 120 coupled to the frame 110. The frame 110 and/or roof 120 define a cabin 130 in which one or more occupants may be seated and/or equipment may be stored. In this manner, the golf cart 100 may be used to transport people and/or objects from one location to another. The cabin 130 is generally open to the ambient environment.

An enclosure panel 140 is removably coupled to the golf cart 100 to at least partially enclose the cabin 130. In this manner, the enclosure panel 140 may be used to provide at least some protection for the occupants and/or equipment from the ambient environment. In some examples, a valance 150 is removably coupled to the enclosure panel 140. The valance 150 extends across an upper portion of the golf cart 100 and/or enclosure panel 140 to shield at least a portion of the golf cart 100, frame 110, and/or enclosure panel 140. While FIG. 1 shows a smaller (e.g., two person) golf cart, the systems and methods described herein may be used with any open-sided vehicle, including larger (e.g., four person, six person, eight person) golf carts.

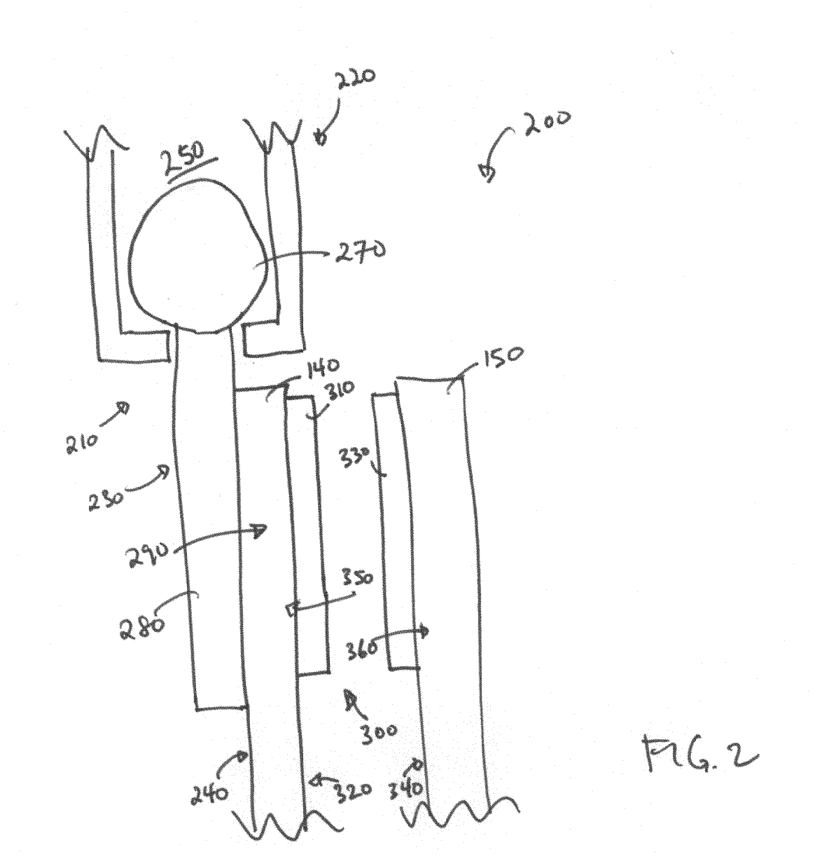

FIG. 2 shows an example system 200 that may be used to shield a portion of a vehicle, such as the golf cart 100 (shown in FIG. 1). The system 200 includes an enclosure panel 140, and a first coupling mechanism 210 removably coupling the enclosure panel 140 to the golf cart 100.

In some examples, the first coupling mechanism 210 includes a track 220 coupled to the golf cart 100 and a root element 230 coupled to an inner surface 240 of the enclosure panel 140. The track 220 may provide a lightweight yet durable framework for support and rigidity for the roof 120. The track 220 may be fabricated from a variety of materials, such as an aluminum material. In some examples, the track 220 is fabricated from an extrudable material at a variety of lengths, widths, thicknesses, and/or shapes such that the track 220 may be mitered, punched, repaired, or otherwise processed to function as described herein.

In some examples, the track 220 at least partially circumscribes a body portion of the roof 120. For example, the track 220 may extend generally about a periphery of the roof 120 along one or more edge portions of the roof 120. The track 220 is configured to retain at least a portion of the root element 230 for coupling the enclosure panel 140 to the golf cart 100.

The root element 230 is configured to engage the track 220 such that the enclosure panel 140 is removably coupleable to the golf cart 100. For example, the track 220 may define a channel 250, and the root element 260 may include a cord 270 sized to fit within the channel 250. The root element 260 includes an arm 280 extending generally downward from the cord 270 and coupled to the inner surface 240 of the enclosure panel 140. For example, a portion of the root element 260 (e.g., a distal portion of the arm 280) may extend across an upper section 290 of the enclosure panel 140. As shown in FIG. 2, the enclosure panel 140 may extend generally downward and/or hang from the root element 260 to at least partially enclose the cabin 130 (shown in FIG. 1).

The system 200 includes a valance 150, and a second coupling mechanism 300 removably coupling the valance 150 to the enclosure panel 140. In some examples, the second coupling mechanism 300 includes a first portion 310 coupled to an outer surface 320 of the enclosure panel 140 and a second portion 330 coupled to an inner surface 340 of the valance 150. For example, the first portion 310 may extend across an upper section 350 of the enclosure panel 140 at the outer surface 320 of the enclosure panel 140, and the second portion 330 may extend across an upper section 360 of the valance 150 at the inner surface 340 of the valance 150.

The second portion 330 is configured to engage the first portion 310 such that the valance 150 is removably coupleable to the enclosure panel 140. The second coupling mechanism 300 may be a hook and loop fastener, for example. In some examples, the first portion 310 is or includes a plurality of hooks or a plurality of loops, and the second portion 330 is or includes the other (e.g., a plurality of loops or a plurality of hooks). Alternatively, the first portion 310 and/or second portion 330 may have any configuration that enable the valance 150 to be removably coupleable to the enclosure panel 140.

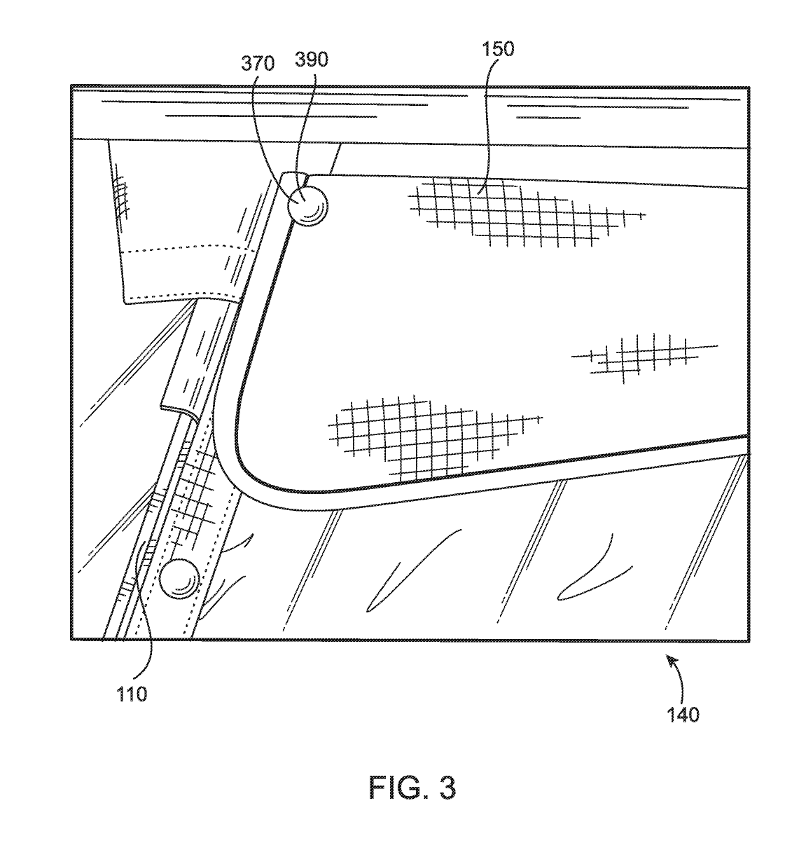

FIGS. 3-5 show the system 200 in a variety of configurations. As shown in FIGS. 3-5, the valance 150 may be selectively coupled to or uncoupled from the enclosure panel 140 in one of a variety configurations.

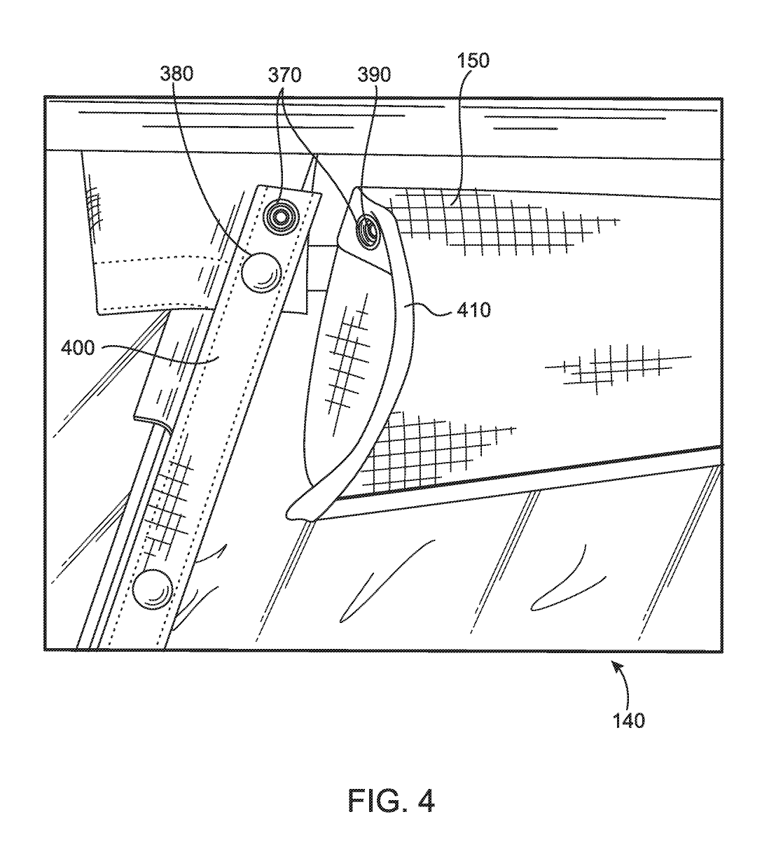

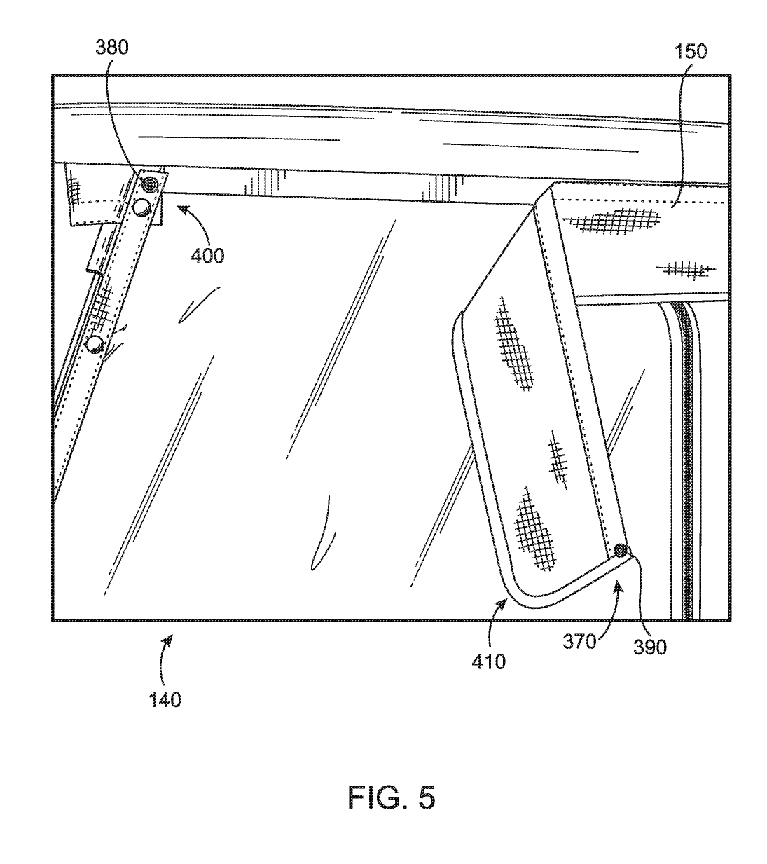

When the valance 150 is selectively coupled to the enclosure panel 140 along a length of the valance 150 (e.g., the second portion 330 of the second coupling mechanism 300 engages the first portion 310 of the second coupling mechanism 300), for example, the valance 150 is considered to be in an engaged configuration. FIG. 3 shows a portion of the system 200 in the engaged configuration. When at least a portion of the valance 150 is uncoupled from the enclosure panel 140 (e.g., a section of the second portion 330 does not engage the first portion 310), the valance 150 is considered to be in a disengaged configuration. FIGS. 4 and 5 show the system 200 in various stages of the disengaged configuration. When the valance 150 is selectively uncoupled from the enclosure panel 140 along the length of the valance 150 such that the valance 150 is free from the enclosure panel 140 (e.g., no section of the valance 150 or the second portion 330 is coupled to the enclosure panel 140 or the first portion 310), then the valance 150 may be considered to be in a completely disengaged configuration.

To couple the valance 150 to the enclosure 140, the valance 150 may be selectively pressed onto the enclosure 140 along an upper section 360 of the valance 150, which, in turn, engages the upper section 350 of the enclosure panel 140. The second portion 330 of the second coupling mechanism 300 (e.g., a plurality of hooks) may extend across the upper section 360 of the valance 150, and the first portion 310 of the second coupling mechanism 300 (e.g., a plurality of loops) may extend across the upper section 350 of the enclosure panel 140. In some examples, the second portion 330 engages the first portion 310 along various segments of the upper section 360 and/or upper section 350 to selectively couple the valance 150 to the enclosure panel 140.

In some examples, the system 200 includes a third coupling mechanism 370 that enables the valance 150 to be coupled to the enclosure panel 140 in a manner different from the second coupling mechanism 300. The third coupling mechanism 370 may provide, for example, fewer opportunities for coupling the valance 150 to the enclosure panel 140 (e.g., fewer contact points, less surface area). Additionally or alternatively, the third coupling mechanism 370 may provide a more robust coupling than the second coupling mechanism 300 (e.g., stronger hold, more resistance from uncoupling).

The third coupling mechanism 370 includes one or more first members 380 coupled to the outer surface 320 of the enclosure panel 140 and one or more second members 390 coupled to the inner surface 340 of the valance 150. In some examples, each end segment 400 (e.g., front end, rear end, left end, right end) of the upper section 350 of the enclosure panel 140 includes a respective first member 380 of the one or more first members 380, and each end segment 410 (e.g., front end, rear end, left end, right end) of the upper section 360 of the valance 150 includes a respective a second member 390 of the one or more second member 390.

The second members 390 are configured to engage the first members 380 such that the valance 150 is removably coupleable to the enclosure panel 140. The third coupling mechanism 370 may be snap fasteners, for example. In some examples, the first member 380 is or includes a socket (e.g., a female component) or a stud (e.g., a male component), and the second member 390 is or includes the other (e.g., a stud or a socket). Alternatively, the first member 380 and/or second member 390 may have any configuration that enable the valance 150 to be removably coupleable to the enclosure panel 140. In some examples, the second member 390 includes a cap at an outer surface of the valance 150 opposite its component (e.g., the stud or the socket). That is, the second member 390 may include a stud or a socket oriented to face the enclosure panel 140 (e.g., toward the first member 380) and a cap oriented to face outward (e.g., away from the first member 380, toward others not in the golf cart).

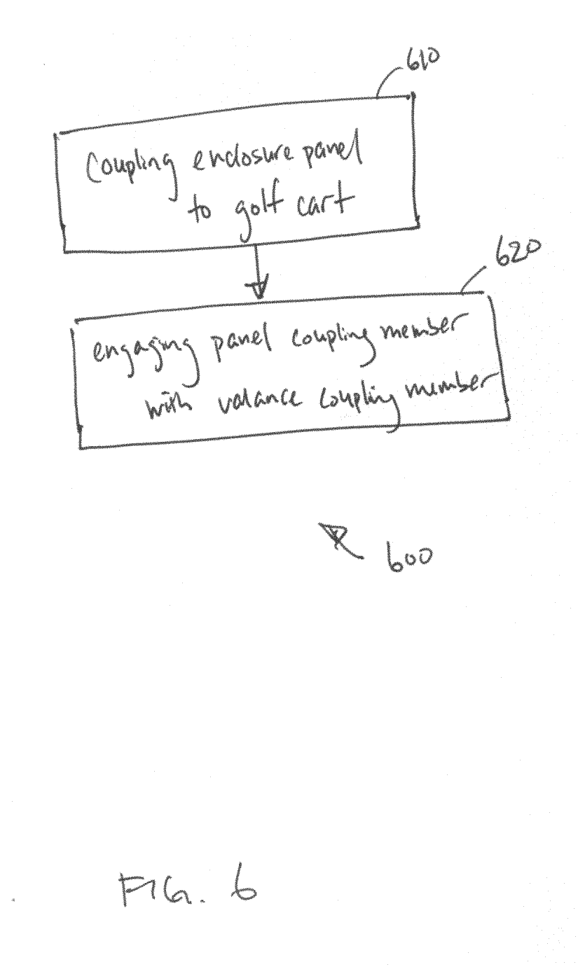

FIG. 6 shows an example method 600 of shielding a portion of the golf cart 100 using the system 200. An enclosure system is coupled to the golf cart 100. The enclosure system may include, for example, an enclosure panel (e.g., enclosure panel 140) having an inner surface (e.g., inner surface 240) and an outer surface (e.g., outer surface 320) opposite the inner surface. The enclosure system further includes a first panel coupling member (e.g., root element 230) coupled to the inner surface of the enclosure panel, and a second panel coupling member (e.g., first portion 310) coupled to the outer surface of the enclosure panel.

The first panel coupling member may be used, for example, to couple the enclosure panel to the golf cart 100 at operation 610. The first panel coupling member is configured to engage a cart coupling member (e.g., track 220) coupled to the golf cart 100 for removably coupling the enclosure panel to the golf cart 100. The first panel coupling member may include, for example, a cord (e.g., root element 260) extendable through a channel defined by the card coupling member (e.g., channel 250), and an arm extending from the cord (e.g., arm 280). The cord is sized to fit within the channel defined by the card coupling member to enable the enclosure panel to be removably coupleable to the golf cart 100. In some examples, the first panel coupling member extends across an upper section of the enclosure panel (e.g., upper section 350).

The second panel coupling member engages a first valance coupling member (e.g., second portion 330) at operation 620. The first valance coupling member is coupled to a valance (e.g., valance 150) for removably coupling the valance to the enclosure panel. In this manner, the second panel coupling member may engage the first valance coupling member for removably coupling the enclosure panel to the valance. The second panel coupling member may be include, for example, a plurality of hook fasteners or a plurality of loop fasteners, and the first valance coupling member may be or include the other of the plurality of hook fasteners or the plurality of loop fasteners. In some examples, the first valance coupling member extends across an upper section of the valance (e.g., upper section 360).

In some examples, another coupling mechanism (e.g., third coupling mechanism 370) enables the valance to be removably coupled to the enclosure panel. The enclosure system, for example, may include one or more third panel coupling members (e.g., first members 380) coupled to the outer surface of the enclosure panel. In some examples, at least one of the third panel coupling members extends through the enclosure panel such that the third panel coupling member is coupled to the inner surface of the enclosure panel.

The third panel coupling members are configured to engage one or more second valance coupling members (e.g., second members 390) coupled to the valance for removably coupling the enclosure panel to the valance. For example, at least one third panel coupling member may be or include a socket or a stud, and a corresponding second valance coupling member may be or include the other of the socket or the stud. The second valance coupling members are coupled to an inner surface of the valance (e.g., inner surface 340). In some examples, at least one of the second valance coupling members extends through the valance such that the second valance coupling member is coupled to an outer surface of the valance. At least one of the third panel coupling members is at an end segment (e.g., end segment 400) of the upper section of the enclosure panel, and at least one of the second valance coupling members is at an end segment (e.g., end segment 410) of the upper section of the valance.

The methods and systems described herein enable a valance to be uncoupled and removed from an enclosure system and/or enclosure panel without otherwise affecting the enclosure system and/or enclosure panel (e.g., the enclosure system may remain coupled to the golf cart 100). The enclosure panel-valance interface described herein (e.g., second coupling mechanism 300, third coupling mechanism 370) enables a valance coupling member (e.g., second portion 330, second members 390) to be disengaged and removed from a panel coupling member (e.g., first portion 310, first member 380) without undergoing the difficult, onerous, and/or time-consuming measures required when removing known coupling mechanisms used to couple valances to enclosure panels (e.g., stitches, glue), such as removing stitches, using a seam ripper, and/or dissolving, removing, or breaking a glue or adhesive, while still allowing the valance coupling member to be re-engaged and coupled to the panel coupling member in a convenient, efficient, safe, and/or economical manner. Accordingly, the methods and systems described herein enable one or more valances to be selectively installed and/or uninstalled in ways not possible with known valances, where one valance may be uncoupled from the enclosure panel and another panel may be coupled to the enclosure panel with ease.

Example enclosure systems are described herein and illustrated in the accompanying drawings. This written description uses examples to disclose aspects of the disclosure and also to enable a person skilled in the art to practice the aspects, including making or using the above-described devices, assemblies, and/or systems and executing or performing the above-described operations. When introducing elements of the disclosure or the examples thereof, the articles “a,” “an,” “the,” and “said” are intended to mean that there are one or more of the elements. References to an “embodiment” or an “example” of the present disclosure are not intended to be interpreted as excluding the existence of additional embodiments or examples that also incorporate the recited features. Moreover, the terms “comprising,” “including,” and “having” are intended to be inclusive and mean that there may be additional elements other than the listed elements. Furthermore, the phrase “one or more of the following: A, B, and C” means “at least one of A and/or at least one of B and/or at least one of C.”

While aspects of the disclosure have been described in terms of various examples with their associated operations, a person skilled in the art would appreciate that a combination of operations from any number of different examples is also within the scope of the disclosure. For example, components of the systems described herein and/or operations of the methods described herein may be utilized independently and separately from other components and/or operations. Moreover, the order of execution or performance of the operations described herein and illustrated in the accompanying drawings is not essential, unless otherwise specified. That is, the operations may be performed in any order, unless otherwise specified, and the methods described herein may include additional or fewer operations than those disclosed herein. For example, it is contemplated that executing or performing a particular operation before, contemporaneously with, or after another operation is within the scope of the disclosure. Although specific features may be shown in some of the accompanying drawings and not in others, this is for convenience only. In accordance with the examples described herein, any feature of a drawing may be referenced and/or claimed in combination with any feature of any other drawing.

Having described aspects of the disclosure in detail, it will be apparent that modifications and variations are possible without departing from the scope of the disclosure as defined in the appended claims. That is, aspects of the disclosure are not limited to the specific examples described herein, and all matter contained in the above description and shown in the accompanying drawings shall be interpreted as illustrative and not in a limiting sense. The scope of the disclosure may include other examples that occur to those skilled in the art. Such other examples are intended to be within the scope of the appended claims if they have structural elements that do not differ from the literal language of the claims, and/or if they include equivalent structural elements with insubstantial differences from the literal language of the claims.

What is claimed is:

1. A system for shielding a portion of a golf cart, the system comprising:
an enclosure panel having an outer surface;
a first coupling mechanism coupling the enclosure panel to the golf cart;
a valance having an inner surface; and
a second coupling mechanism including a first portion coupled to the outer surface of the enclosure panel and a second portion coupled to the inner surface of the valance, the second portion configured to engage the first portion such that the valance is removably coupleable to the enclosure panel.

2. The system of claim 1, wherein the first portion extends across an upper section of the enclosure panel.

3. The system of claim 1, wherein the second portion extends across an upper section of the valance.

4. The system of claim 1, wherein the first coupling mechanism includes a track coupled to the golf cart and a root element coupled to an inner surface of the enclosure panel, the root element configured to engage the track such that the enclosure panel is removably coupleable to the golf cart.

5. The system of claim 4, wherein the track defines a channel, and the root element includes a cord sized to fit within the channel and an arm extending from the cord.

6. The system of claim 4, wherein a portion of the root element extends across an upper section of the enclosure panel.

7. The system of claim 1 further comprising a third coupling mechanism including one or more first members coupled to the outer surface of the enclosure panel and one or more second members coupled to the inner surface of the valance, the one or more second members configured to engage the one or more first members such that the valance is removably coupleable to the enclosure panel.

8. The system of claim 7, wherein at least one first member of the one or more first members is at an end segment of an upper section of the enclosure panel.

9. The system of claim 7, wherein at least one second member of the one or more second members is at an end segment of an upper section of the valance.

10. An enclosure system for shielding a portion of a golf cart, the enclosure system comprising:
an enclosure panel having an inner surface and an outer surface opposite the inner surface;
a first panel coupling member coupled to the inner surface of the enclosure panel, the first panel coupling member configured to engage a cart coupling member coupled to the golf cart for removably coupling the enclosure panel to the golf cart; and
a second panel coupling member coupled to the outer surface of the enclosure panel, the second panel coupling member configured to engage a first valance coupling member coupled to a valance for removably coupling the enclosure panel to the valance.

11. The enclosure system of claim 10, wherein the first panel coupling member extends across an upper section of the enclosure panel.

12. The enclosure system of claim 10, wherein the second panel coupling member extends across an upper section of the enclosure panel.

13. The enclosure system of claim 10, wherein the first panel coupling member includes a cord and an arm extending from the cord, the cord sized to fit within a channel defined by the cart coupling member.

14. The enclosure system of claim 10, wherein the second panel coupling member includes one of a plurality of hook fasteners or a plurality of loop fasteners, and the first valance coupling member includes the other of the plurality of hook fasteners or the plurality of loop fasteners.

15. The enclosure system of claim 10 further comprising one or more third panel coupling members coupled to the outer surface of the enclosure panel, the one or more third panel coupling members configured to engage one or more second valance coupling members coupled to the valance for removably coupling the enclosure panel to the valance.

16. The enclosure system of claim 15, wherein at least one of the one or more third panel coupling members is at an end segment of an upper section of the enclosure panel.

17. The enclosure system of claim 15, wherein at least one of the one or more third panel coupling members extends through the enclosure panel and is coupled to an inner surface of the enclosure panel.

18. The enclosure system of claim 15, wherein at least one of the one or more third panel coupling members includes one of a socket or a stud, and at least one of the one or more second valance coupling members includes the other of the socket or the stud.

19. A method of shielding a portion of a golf cart, the method comprising:
coupling an enclosure panel to the golf cart, the enclosure panel having an outer surface with a panel coupling member extending across an upper section of the enclosure panel; and
engaging the panel coupling member with a valance coupling member coupled to a valance for removably coupling the valance to the enclosure panel, the valance coupling member extending across an upper section of the valance.

20. The method of claim 19 further comprising:
engaging one or more first members coupled to the outer surface of the enclosure panel with one or more second members coupled to the valance for removably coupling the valance to the enclosure panel, the one or more first members at opposing end segments of the upper section of the enclosure panel, the one or more second members at opposing end segments of the upper section of the valance.
